(19) United States
(12) Patent Application Publication
(10) Pub. No.: US 2009/0135685 A1
(43) Pub. Date: May 28, 2009

(54) ABERRATION CORRECTING APPARATUS AND PROGRAM FOR CORRECTING ABERRATION

(75) Inventors: Noriaki Murao, Saitama (JP); Junichi Furukawa, Saitama (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation, Tokyo (JP)

(21) Appl. No.: 12/065,761

(22) PCT Filed: Sep. 4, 2006
(86) PCT No.: PCT/JP2006/317459

§ 371 Date: Mar. 5, 2008

(30) Foreign Application Priority Data
Sep. 6, 2005 (JP) 2005-257728

(51) Int. Cl. G11B 7/135

(52) U.S. Cl. 369/44.32; G9B/7.128

(57) ABSTRACT

An aberration correcting apparatus is provided, which is capable of suppressing occurrence of abnormal operation in an actuator for a tracking servo by reducing track cross noise caused by astigmatism in a 45-degree direction in which influence is exerted on the tracking servo.

A control is performed by using a CPU 12 and a selector 3 so as to optimize an astigmatism correction amount in a liquid crystal panel in a state where a tracking servo loop is open and in a state where the tracking servo loop is closed.

### TECHNICAL FIELD

The present invention relates to the technical field of an aberration correcting apparatus and a program for correcting aberration. More particularly, the invention relates to the technical field of an aberration correcting apparatus for optically correcting astigmatism included in a light beam used at the time of optically recording or reproducing information and to an aberration correcting program used for the aberration correction.

### BACKGROUND ART

Generally, in the case of optically recording/reproducing information with a light beam such as a laser beam to/from an optical disk such as a CD (Compact Disc) or DVD (Digital Versatile Disc), there is a case that so-called astigmatism remains in the light beam due to, for example, precision of an optical part in a pickup or the recording/reproduction, noise included in a laser, and the like. When astigmatism remains in the light, drawbacks such as decrease in the amplitude of a detected RF (Radio Frequency) signal, leakage of a tracking error signal component to a focus error signal, and the like occur.

As a conventional method of correcting the astigmatism, for example, as disclosed in the following patent document 1, a method of correcting the astigmatism by disposing a liquid crystal panel capable of partly controlling an aberration amount in a light flux of a light beam on the optical path of the light beam and controlling the drive state of the liquid crystal panel is used.

Concretely, as the astigmatism correcting method using the liquid crystal panel, while changing an aberration correction amount in the liquid crystal panel, the amplitude of the RF signal is detected, and a correction amount at which the value becomes the maximum is applied as an aberration correction amount to all of the cases.

Patent Document 1: Japanese Unexamined Patent Application Publication No. 2000-40249 (FIGS. 2, 4, and 6 and the like)

### DISCLOSURE OF THE INVENTION

### Problems to be Solved by the Invention

However, by the conventional astigmatism correcting method, that is, a method of calculating an astigmatism correction amount by paying attention only to the amplitude of an RF signal, so-called astigmatism in the 45-degree direction (45-degree AS) remains in a light beam even after the correction.

In this case, the quality of an RF signal is excellent. On the other hand, due to the astigmatism in the 45-degree direction, a phenomenon occurs such that a tracking error signal for tracking servo with respect to the light condensing position of a light beam leaks as disturbance to a focus error signal for focus servo to the light condensing position. In the following, noise occurring in the focus error signal due to the disturbance will be called track cross noise.

On the other hand, for example, at the time of a track search for retrieving a track on an optical disk, when a track servo loop is in an open state in an optical disk having large decentering, the number of times the light beam condensing position crosses tracks formed on the optical disk per unit time increases. In this case, the track cross noise further increases and, accordingly, a noise component in the focus error signal increases. As a result, excessive current flows in an actuator for focus servo. A problem arises such that it can cause destruction of the actuator.

The present invention has been achieved in view of the problem, and an object of the invention is to provide an aberration correcting apparatus and an aberration correcting program capable of suppressing occurrence of abnormal operation in a servo actuator by reducing track cross noise caused by astigmatism in the 45-degree direction in which an influence is exerted on the focus servo.

### Means for Solving the Problems

In order to solve the above problems, the invention according to claim 1 relates to an aberration correcting apparatus comprising:

correcting means for optically correcting astigmatism included in a light beam used for optically recording and/or reproducing information to/from a recording medium;

storing means for storing first correction amount information indicative of a correction amount of the astigmatism when a tracking servo loop for controlling a condensing position of the light beam in a direction parallel to an information recording face in the recording medium is in a closed state and second correction amount information indicative of a correction amount of the astigmatism when the tracking servo loop is in an open state; and

switching output means, in the closed state, for reading the stored first correction amount information from the storing means and outputting the read first correction amount information to the correcting means and, in the open state, for reading the stored second correction amount information from the storing means and outputting the read second correction amount information to the correcting means,

wherein the correcting means corrects the astigmatism by using either the first correction amount information or the second correction amount information which is output.

In order to solve the above problems, the invention according to claim 8 relates to an aberration correcting program for making a computer included in an aberration correcting apparatus having correcting means for optically correcting astigmatism included in a light beam used for optically recording and/or reproducing information to/from a recording medium, and for correcting the astigmatism by using either first correction amount information or the second correction amount information, function as:

storing means for storing the first correction amount information indicative of a correction amount of the astigmatism when a tracking servo loop for controlling a condensing position of the light beam in a direction parallel to an information recording face in the recording medium is in a closed state, and the second correction amount information indicative of a correction amount of the astigmatism when the tracking servo loop is in an open state; and

switching output means, in the closed state, for reading the stored first correction amount information from the computer functioning as the storing means and outputting the read first correction amount information to the correcting means and, in the open state, reading the stored second correction amount information from the computer functioning as the storing means and outputting the read second correction amount information to the correcting means.

### BRIEF DESCRIPTION OF DRAWINGS

FIG. 1 is a block diagram showing a schematic configuration of an aberration correcting apparatus according to a first embodiment.

FIG. 2 is a flowchart showing general operations of the aberration correcting apparatus according to the first embodiment.

FIG. 3 is a flowchart showing detailed operation of the aberration correcting apparatus according to the first embodiment.

FIG. 4 is a block diagram showing a schematic configuration of an aberration correcting apparatus according to a second embodiment.

FIG. 5 is a flowchart showing detailed operation of the aberration correcting apparatus according to the second embodiment.

FIG. 6 is a block diagram showing a schematic configuration of an aberration correction apparatus according to a third embodiment.

FIG. 7 is a flowchart showing detailed operation of the aberration correcting apparatus according to the third embodiment.

### DESCRIPTION OF REFERENCE NUMERALS

1 pickup
2 liquid crystal panel
3 selector
4 tracking error generator
5 focus error generator
6 RF signal generator
7 amplitude detector
8 residual error detector
9 decoder
10 jitter/error rate detector
12 CPU
15 maximum value detector
S1, S2, S3 aberration correcting apparatus
B light beam
DK optical disk

### BEST MODE FOR CARRYING OUT INVENTION

Best modes for carrying out the invention will now be described with reference to the drawings. The following embodiments relate to the case of applying the invention to an astigmatism correcting apparatus mounted on an information reproducing apparatus for reproducing information from an optical disk as a recording medium such as a CD and for correcting the astigmatism which occurs in a light beam provided for the reproduction.

### (I) First Embodiment

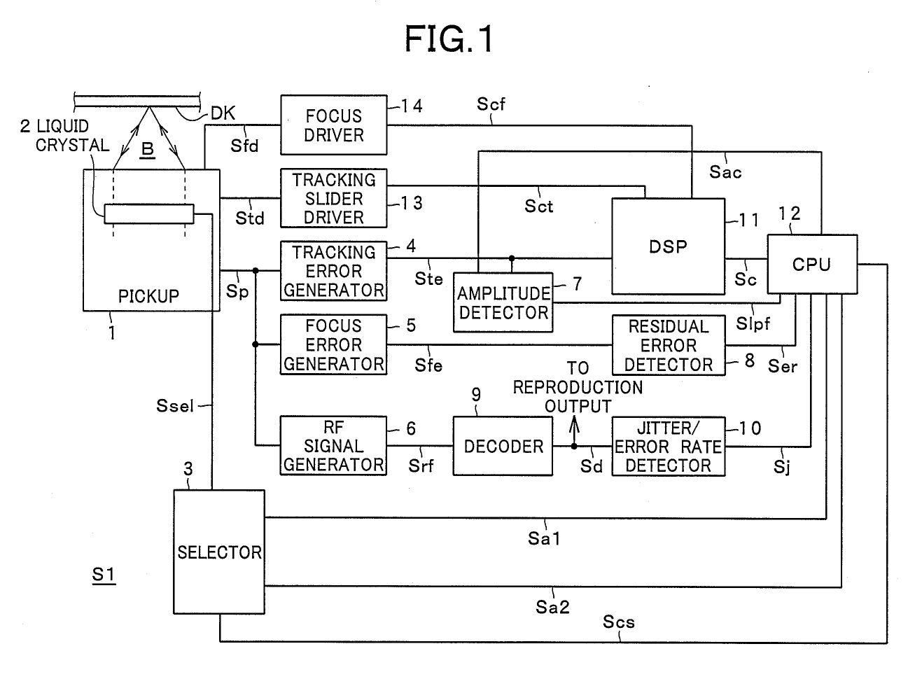

A first embodiment of the present invention will be described with reference to FIGS. 1 to 3.

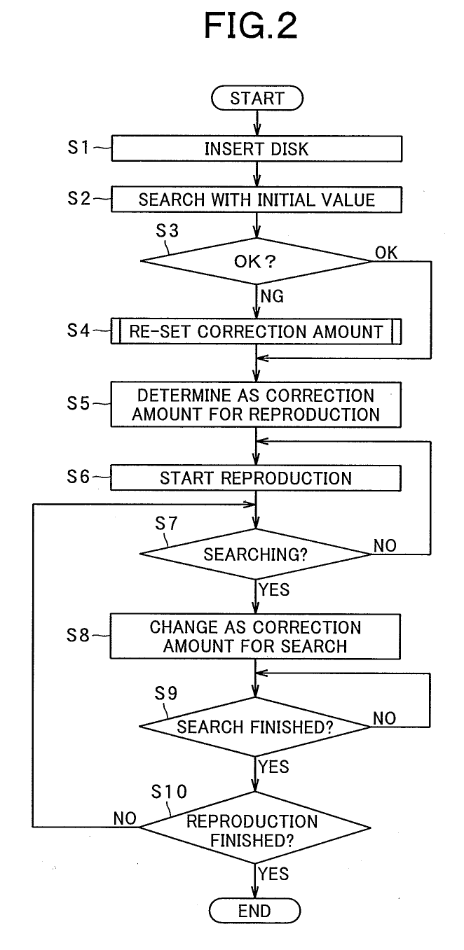

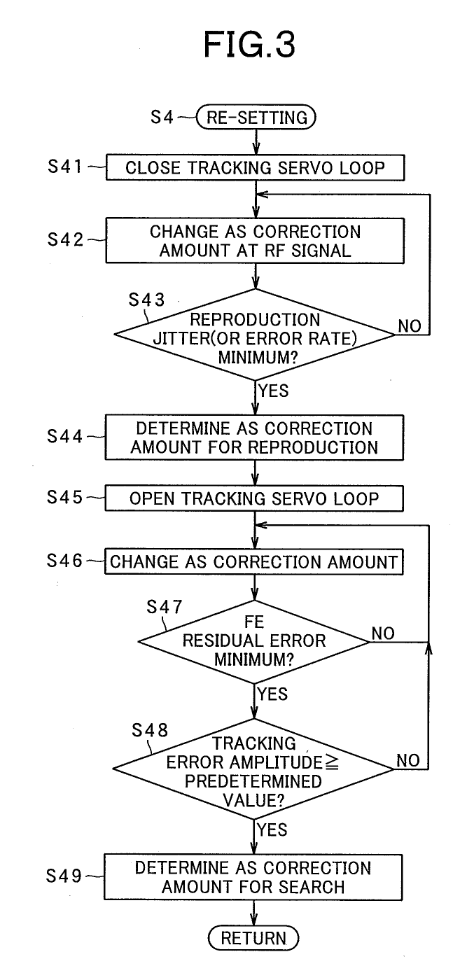

FIG. 1 is a block diagram showing a schematic configuration of an aberration correcting apparatus according to a first embodiment. FIG. 2 is a flowchart showing general operations of reproducing process including aberration correcting process by the aberration correcting apparatus. FIG. 3 is a flowchart showing detailed operation of the aberration correcting apparatus.

As shown in FIG. 1, an aberration correcting apparatus S1 of a first embodiment is constructed by a liquid crystal panel 2 as correcting means disposed on an optical path of a light beam B in a pickup 1 for emitting the light beam B and receiving reflection light from an optical disk DK, a selector 3 as switching output means, a tracking error generator 4, a focus error generator 5, an RF signal generator 6, an amplitude detector 7 as amplitude detecting means, a residual error detector 8 as error detecting means, a decoder 9, a jitter/error rate detector 10 as detecting means, a DSP (Digital Signal Processor) 11, a CPU 12 as storing means and storage control means, a tracking slider driver 13, and a focus driver 14.

In the configuration, to correct astigmatism which occurs in the light beam B passing through a liquid crystal face in the liquid crystal panel 2, the liquid crystal panel 2 gives a phase difference according to a passing part in the liquid crystal face to the light beam B. For this purpose, the liquid crystal panel 2 has a transparent electrode divided in a shape by which the phase difference for correcting the astigmatism to each part in a section of the light flux of the light beam B. On the basis of a control signal Ssel which will be described later from the selector 3 (the control signal Ssel applied to each of the transparent electrodes divided), the liquid crystal panel 2 is driven every region corresponding to the divided transparent electrodes.

On the other hand, the light beam B emitted from a not-shown laser light source in the pickup 1 and reflected by the optical disk DK is received by a not-shown photodetector in the pickup 1, and output as a light reception signal Sp to the tracking error generator 4, the focus error generator 5, and the RF signal generator 6.

On the basis of the input detection signal Sp, the tracking error generator 4 generates a tracking error signal Ste indicative of a deviation in a direction parallel with the information recording face of the optical disk DK between a position on the optical disk DK to which the light beam B is to be focused and an actual light condensing position by using a known method. The tracking error generator 4 outputs the tracking error signal Step to the amplitude detector 7 and the DSP 11.

The amplitude detector 7 constructed by a not-shown LPF (Low Pass Filter), an envelope detector, and the like detects the amplitude of the input tracking error signal Ste, generates an amplitude signal Sac indicative of the detected amplitude, and outputs it to the CPU 12. The features (such as cutoff frequency in the LPF) related to the amplitude detecting process in the amplitude detector 7 are set on the basis of a control signal Slpf from the CPU 12.

On the basis of the input detection signal Sp, the focus error generator 5 generates a focus error signal Sfe indicative of a deviation in a direction perpendicular to the information recording face between a position on the optical disk DK to which the light beam B is to be condensed and an actual light condensing position by using a known method. The tracking error generator 4 outputs the focus error signal Sfe to the residual error detector 8.

On the basis of the input focus error signal Sfe, the residual error detector 8 detects a value of a residual error in the focus error signal Sfe (that is, a focus error component residing in the focus error signal Sfe in a state where the focus servo is on), generates a residual error signal Ser indicative of the detected value, and outputs the residual error signal Ser to the CPU 12.

Further, the RF signal generator 6 generates an RF signal Srf corresponding to information recorded on the optical disk DK on the basis of the input detection signal Sp by using a known method and outputs the generated signal to the decoder 9.

The decoder 9 decodes the information recorded on the optical disk DK from the RF signal Srf by using a preset decoding method, thereby generating a decode signal Sdc. The decoder 9 outputs the decode signal Sdc to a not-shown reproducing processor and also to the jitter/error rate detector 10. In the reproducing processor, a process of reproducing the information recorded on the optical disk DK by using the decode signal Sdc is executed.

The jitter/error rate detector 10 detects either a jitter component included in the decode signal Sdc or an error rate in the decode signal Sdc, generates a jitter/error rate signal Sj indicative of either the detected jitter component value or error rate, and outputs the jitter/error rate signal Sj to the CPU 12.

On the other hand, the DSP 11 generates a control signal Sct for driving the tracking slider driver 13 on the basis of the tracking error signal Step from the tracking error generator 4 while transmitting/receiving the control signal Sc to/from the CPU 12, and outputs the control signal Sct to the tracking slider driver 13.

The tracking slider driver 13 to which the control signal Sct is input generates a drive signal Std for driving a not-shown tracking actuator in the pickup 1 on the basis of the control signal Sct, and outputs the drive signal Std to the tracking actuator. When the position in which the light beam B is to be condensed and the actual condensing position in the direction parallel with the information recording face exceeding a position-controllable range by the tracking servo, a not-shown slider actuator for moving the pickup 1 itself is driven by the drive signal Std, thereby cancelling the positional deviation in the direction parallel to the information recording face.

In addition, the DSP 11 generates a control signal Scf for driving the focus driver 14 on the basis of the focus error signal Sfe transmitted via the CPU 12 and outputs the generated control signal Scf to the focus driver 14.

The focus driver 14 to which the control signal Scf is input generates the drive signal Sfd for driving a not-shown focus actuator in the pickup 1 on the basis of the control signal Scf, and outputs the drive signal Sfd to the focus actuator. The focus actuator corrects the deviation in the direction perpendicular to the information recording face between the position in which the light beam B is to be condensed and the actual condensing position on the basis of the input drive signal Sfd.

In parallel with the operations of the components described above, the CPU 12 outputs, as the control signal Sc, the focus error signal Sfe output from the focus error generator 5 to the DSP 11, executes a process of calculating an aberration correction amount in the first embodiment which will be described later on the basis of the amplitude signal Sac, the residual error signal Ser, and the jitter/error rate signal Sj, generates correction amount signals Sa1 and Sa2 indicative of two aberration correction amounts obtained as a result of the calculating process, temporarily stores the correction amount signals Sa1 and Sa2, and outputs the correction amount signals Sa1 and Sa2 to the selector 3 at timings which will be described later.

The aberration correction amount indicated by the correction amount signal Sa1 is a correction amount signal indicative of an aberration correction amount to be used for aberration correction by the liquid crystal panel 2 when the tracking servo loop is closed (close state, concretely, when information is reproduced or at the time of layer switch on a multilayer disk). The aberration correction amount indicated by the correction amount signal Sa2 is a correction amount signal indicative of an aberration correction amount to be used for aberration correction by the liquid crystal panel 2 when the tracking servo loop is open (open state, concretely, at the time of track search).

In the CPU 12, at the time of manufacture of the information reproducing apparatus including the aberration correcting apparatus S1 of the first embodiment, an initial value of the aberration correction amount to be used for correction by the liquid crystal panel 2 when the tracking servo loop is closed and an initial value of the aberration correction amount to be used for correction by the liquid crystal panel 2 when the tracking servo loop is open are preset and stored.

Further, the CPU 12 generates a control signal Scs for controlling to select either a way of selecting the output correction amount signal Sa1 and outputting it as the control signal Ssel or a way of selecting the correction amount signal Sa2 and outputting it as the control signal Ssel, and similarly outputs the control signal to the selector 3.

Concurrently, the CPU 12 executes necessary processes including processes of generating/outputting the control signals Sc and Slpf to control the whole aberration correcting apparatus S1 in a centralized manner.

Finally, the selector 3 selects either the correction amount signal Sa1 or Sa2 on the basis of the control signal Scs and outputs the selected signal as the control signal Ssel to the liquid crystal panel 2. Consequently, the liquid crystal panel 2 is driven by either the aberration correction amount included in the correction amount signal Sa1 or the aberration correction amount included in the correction amount signal Sa2 on the basis of the output control signal Ssel.

The process of reproducing information from the optical disk DK including the aberration correcting operation of the first embodiment in the aberration correcting apparatus S1 having the above-described general configuration and operation will be concretely described with reference to FIGS. 1 to 3. In the following description and drawings, astigmatism is properly abbreviated as “AS”.

First, the general operation will be described with reference to FIG. 2.

As shown in FIG. 2, in the aberration correcting operation of the first embodiment, when the optical disk DK to be reproduced is inserted in the information reproducing apparatus of the first embodiment (step S1), using an aberration correction amount to be used for correction when the tracking servo loop is in an open state among the aberration correction amounts as the initial values recorded in the CPU 12, in the case of using the aberration correction amount as the initial value when the tracking servo loop is in an open state, whether occurrence of excessive current in the focus actuator is recognized or not is determined.

As a concrete recognizing method, there is a method of, for example, observing a residual error included in the focus error signal or the focus drive signal. In the first embodiment, to increase the detection (recognizing) precision, track search operation (that is, track retrieving operation including operation of jumping a plurality of tracks) is actually performed (step S2). A check is made to see whether or not occurrence of excessive current in the focus actuator as described above is recognized in the case of using the initial values (step S3).

When occurrence of the excessive current is not recognized in the check of step S3 (NO in step S3), the two aberration correction amounts stored as the initial values may be used as they are. Consequently, the aberration correction amount to be used when the tracking servo loop is closed among the aberration correction amounts stored as the initial values are set as the aberration correction amounts used for the aberration correction by the liquid crystal panel 2 (step S5). A process of reproducing information from the optical disk DK is started (step S6).

On the other hand, when occurrence of the excessive current is recognized in the check of step S3 (YES in step S3), if nothing is performed, the above-described various problems occur. Therefore, an aberration correction amount re-setting process of the first embodiment which will be described in detail later is performed (step S4). The two re-set aberration correction amounts are stored in the not-shown memory in the CPU 12. Further, the aberration correction amount to be used when the tracking servo loop is closed is set as the aberration correction amount used for correction in the liquid crystal panel 2 (step S5), and the process of reproducing information from the optical disk DK is started (step S6).

In the reproducing process, whether it is designated to execute the track search operation or not is always monitored on the basis of an operation of a not-shown operating unit or the like (step S7). When the operation is not executed (NO in step S7), the reproducing process is continued. On the other hand, when an instruction for the track search operation is given (YES in step S7), the aberration correction amount used when the tracking servo loop is closed is switched to the aberration correction amount used when the tracking servo loop stored in the CPU 12 is open, the aberration correction amount used for the aberration correction in the liquid crystal panel 2 is reset, and the track search operation necessary at that time is performed (step S8).

During the track search operation, whether a track to be retrieved is retrieved or not is monitored (step S9). When retrieval of the track to be retrieved is not finished (NO in step S9), the track search operation is continued. On the other hand, when a necessary track can be searched (YES in step S9), whether the reproducing process itself is finished or not is recognized (step S10).

When reproduction of information recorded on the track after retrieval is continued (NO in step S10), the program returns to the step S7 and the above-described operations are repeated. On the other hand, when the reproduction is finished (YES in step S10), the reproducing process in the first embodiment is finished.

The details of the aberration correction amount re-setting process (step S4) of the first embodiment will now be described concretely with reference to FIG. 3.

In the process of step S4, first, the tracking servo loop is set to the close state (step S41). While irradiating an area where some information is recorded on the optical disk DK (that is, an area from which the RF signal Srf is obtained) with the light beam B, the aberration correction amount used for the aberration correction in the liquid crystal panel 2 is changed (step S42).

Information is detected while changing the aberration correction amount. On the basis of the jitter/error rate signal Sj output from the jitter/error rate detector 10, at least one of a jitter and error rate in the detected information is detected. Whether at least one of the detected jitter and the error rate becomes the minimum or not with the change in the aberration correction amount (step S43) is determined (step S43).

When at least one of the jitter and the error rate has not become the minimum value in the check in step S43 (NO in step S43), the program returns to the process in the step S42 to make a check on the other aberration correction amounts. On the other hand, when at least one of the jitter and the error rate has become the minimum value (YES in step S43), the aberration correction amount at which the minimum value is obtained is set as the aberration correction amount when the tracking servo loop is in the close state, and stored in a not-shown memory in the CPU 12 (step S44).

After that, the tracking servo loop is opened (step S45). While irradiating any area on the optical disk DK with the light beam B, the aberration correction amount used for correction in the liquid crystal panel 2 is changed (step S46).

On the basis of the residual error signal Ser output from the residual error detector 8 with a change in the aberration correction amount when the tracking servo loop is in the open state, a residual error in the focus error signal Sfe is recognized. Whether the residual error becomes the minimum with the change in the aberration correction amount (step S46) or not is determined (step S47).

In the processes of the steps S46 and S47, to increase the detection precision, it is also possible to move the condensing position of the light beam B in the radial direction of the optical disk DK (that is, a track crossing direction) while changing the aberration correction amount, recognize the residual error in the focus error signal Sfe on the basis of the residual error signal Ser output from the residual error detector 8 and, after that, check to see whether the residual error has become the minimum with the change in the aberration correction amount (step S46) (step S47).

When it is determined in the step S47 that the residual error in the focus error signal Sfe has not become the minimum value yet (NO in step S47), the program returns to the process of the step S46 to make a check on the other aberration correction amounts. On the other hand, when the residual error becomes the minimum value (YES in step S47), the amplitude of the tracking error signal Step is recognized on the basis of the amplitude signal Sac output from the amplitude detector 7. Whether the recognized amplitude is equal to or larger than a predetermined threshold or not is determined (step S48).

The reason why the predetermined threshold is set and whether the tracking error signal Ste having the amplitude equal to or larger than the threshold is obtained or not is determined is that, when the amplitude of the tracking error signal Ste becomes small, naturally, the amplitude of the track cross noise becomes small. On the other hand, the gain in the tracking servo also becomes small. As a result, the servo becomes unstable. It is unpreferable to perform an actual tracking servo using the aberration correction amount employed at that time. Consequently, in the aberration correcting operation in the first embodiment, the aberration correction amount by which the amplitude of the tracking error signal Ste becomes a value equal to or larger than the threshold is used.

The threshold value is, basically, experimentally set on the basis of optical properties and the like of the pickup 1 itself. More concretely, for example, the value of about 50% of the maximum value in the amplitude of the tracking error signal Ste is suitable as the threshold.

When it is determined in the step S48 that the amplitude of the tracking error signal Ste is not equal to or larger than the threshold (NO in step S48), the program returns to the process of the step S46 to find another aberration correction amount by which the residual error becomes the minimum and the amplitude of the tracking error signal Ste becomes equal to or larger than the threshold. On the other hand, when the amplitude becomes equal to or larger than the threshold (YES in step S48), the aberration correction amount at that time is regarded as the aberration correction amount when the tracking servo loop is in the open state and stored into a not-shown memory in the CPU 12 (step S49). The program shifts to the process in the step S5 shown in FIG. 2.

As described above, by the operation of the aberration correcting apparatus S1 of the first embodiment, the astigmatism correction amount is optimized by being switched between the state where the tracking servo loop is open and the state where the tracking servo loop is close. As a result, the amount of occurrence of the astigmatism in the 45-degree direction in the open state can be reduced.

Therefore, the track cross noise caused by the astigmatism in the 45-degree direction is reduced, so that occurrence of abnormal operation in the actuator for focus servo can be suppressed.

The astigmatism correction amount applied when the tacking servo loop is in the close state is set so that the jitter amount or the error rate in the decode signal Sd obtained by detecting and decoding information recorded on the optical disk DK becomes the minimum. Thus, the aberration correction amount can be optimized on the basis of actually decoded information.

Further, the astigmatism correction amount applied when the tacking servo loop is in the open state is set so that the residual error in the focus error signal Sfe becomes the minimum and the amplitude of the tracking error signal Ste becomes equal to or larger than the threshold in the state where the tracking servo loop is open. Thus, the astigmatism in the 45-degree direction which occurs in the open state is further reduced, and track cross noise can be further reduced.

Moreover, the aberration correction amounts are updated as necessary when the optical disk DK is inserted in the information reproducing apparatus including the aberration correcting apparatus S1 of the first embodiment. Consequently, the optimum aberration correction amount can be obtained and used for each of the optical disks DK from which recorded information is to be reproduced.

### (II) Second Embodiment

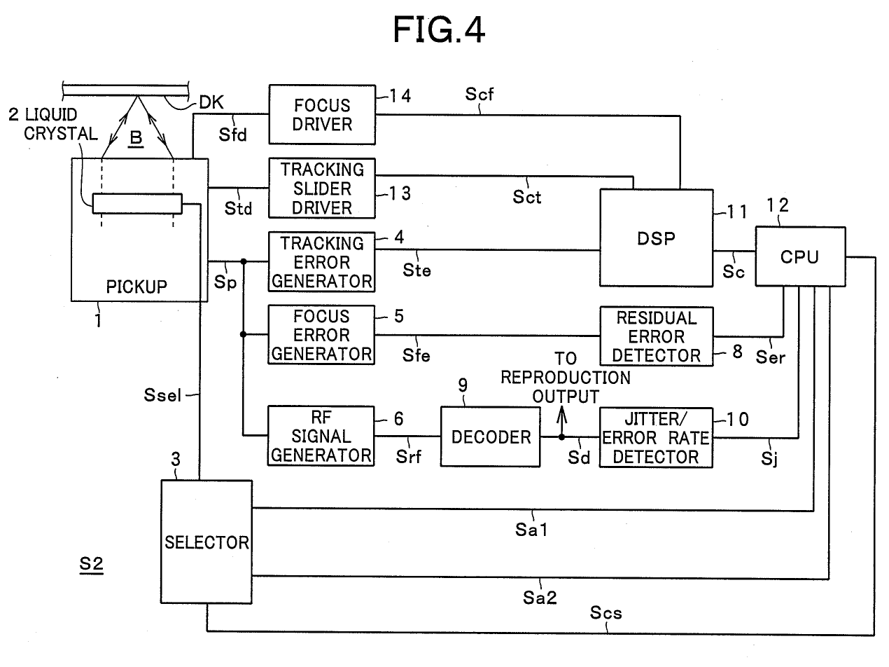

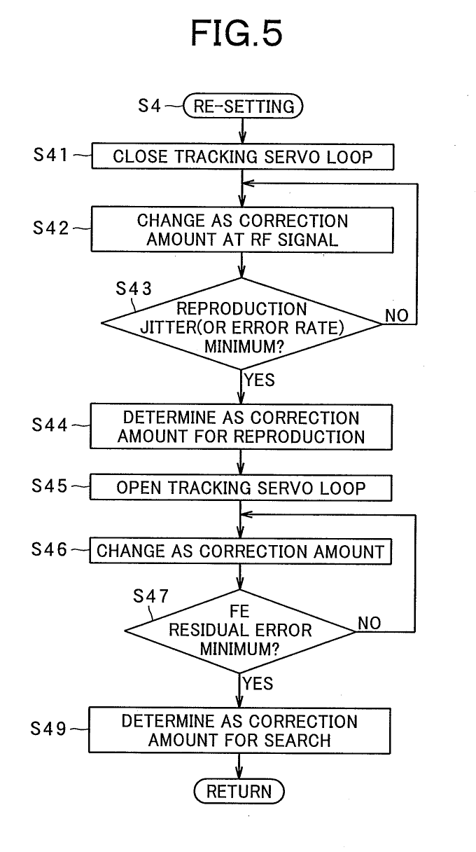

A second embodiment as another embodiment of the present invention will be described with reference to FIGS. 4 and 5.

FIG. 4 is a block diagram showing a schematic configuration of an aberration correcting apparatus according to a second embodiment. FIG. 5 is a flowchart showing operations of an aberration correcting amount re-setting process (refer to step S4 in FIG. 2 and FIG. 3) executed by the aberration correcting apparatus. In FIG. 4, likewise numerals are designated to components similar to those of the aberration correcting apparatus S1 of the first embodiment, and their detailed description will not be repeated. In FIG. 5, likewise step numbers are designated to processes similar to the aberration correction amount re-setting process (refer to FIG. 3) of the first embodiment, and the detailed description will not be repeated.

In the aberration correcting apparatus S1 of the first embodiment, at the time of calculating the aberration correction amount applied when the tracking servo loop is in the open state, both of the residual error in the focus error signal Sfe and the amplitude of the tracking error signal Ste are used. In the following second embodiment, at the time of calculating the aberration correction amount applied when the tracking servo loop is in the open state, only the residual error in the focus error signal Sfe is used.

An aberration correcting apparatus S2 of the second embodiment has a configuration obtained by eliminating the amplitude detector 7 from the aberration correcting apparatus S1 of the first embodiment as shown in FIG. 4.

As an entire reproducing process executed by an information reproducing apparatus including the aberration correcting apparatus S2 of the second embodiment, a process similar to the reproducing process in the first embodiment shown in FIG. 2 is executed. As the aberration correction amount resetting process (step S4 in FIG. 2), process shown in FIG. 5 is executed.

Concretely, as shown in FIG. 5, when the aberration correction amount resetting process starts (step S4), processes similar to those in the steps S41 to S47 shown in FIG. 3 are performed. When it is determined in the step S47 that the residual error in the focus error signal Sfe has not become the minimum value (NO in step S47), the program returns to the process in the step S46 to make a check on another aberration correction amount. On the other hand, when the residual error becomes the minimum value (YES in step S47), the aberration correction amount is set as the aberration correction amount when the tracking servo loop is in the open state and stored in a not-shown memory in the CPU 12 (step S49). The program shifts to the process of step S5 shown in FIG. 2.

As described above, in the operation of the aberration correcting apparatus S2 of the second embodiment, by the operation of the aberration correcting apparatus S2 of the second embodiment, the astigmatism correction amount is optimized by being switched between the state where the tracking servo loop is in the open state and the state where the tracking servo loop is in the close state. As a result, the amount of occurrence of the astigmatism in the 45-degree direction in the open state can be reduced.

Therefore, the track cross noise caused by the astigmatism in the 45-degree direction is also reduced, so that occurrence of abnormal operation in the actuator for tracking servo can be suppressed.

The astigmatism correction amount applied when the tacking servo loop is in the close state is set so that the jitter amount or the error rate in the decode signal Sd obtained by detecting and decoding information recorded on the optical disk DK becomes the minimum. Thus, the aberration correction amount can be optimized on the basis of actually decoded information.

Further, the astigmatism correction amount applied when the tacking servo loop is in the open state is set so that the residual error in the focus error signal Sfe becomes the minimum in the state where the tracking servo loop is open. Thus, the astigmatism in the 45-degree direction which occurs in the open state is further reduced, and track cross noise can be further reduced.

Moreover, the aberration correction amounts are updated as necessary when the optical disk DK is inserted in the information reproducing apparatus including the aberration correcting apparatus S2 of the second embodiment. Consequently, the optimum aberration correction amount can be obtained and used for each of the optical disks DK from which recorded information is to be reproduced.

### (III) Third Embodiment

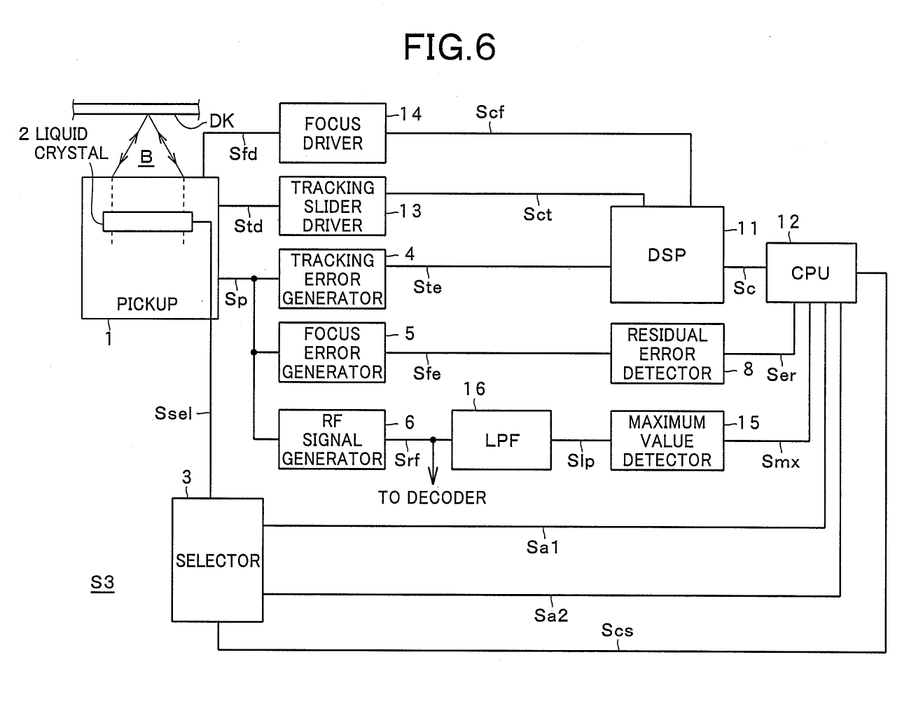

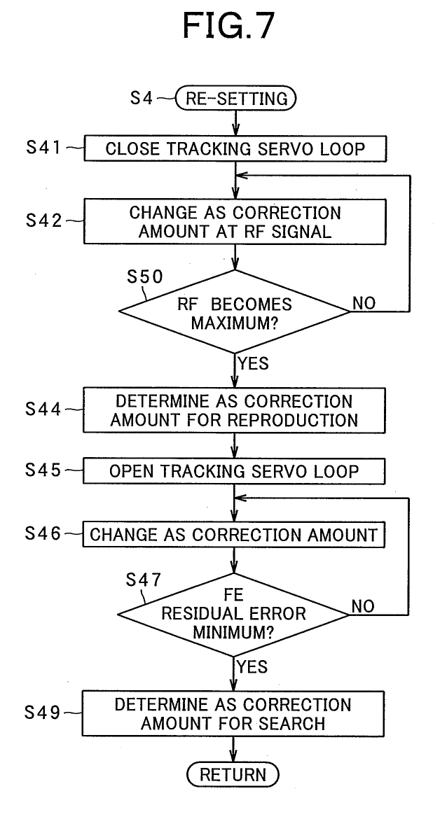

A third embodiment as another embodiment of the present invention will be described with reference to FIGS. 6 and 7.

FIG. 6 is a block diagram showing a schematic configuration of an aberration correcting apparatus according to a third embodiment. FIG. 7 is a flowchart showing operations of an aberration correcting amount re-setting process (refer to step S4 in FIG. 2 and FIG. 3) executed by the aberration correcting apparatus. In FIG. 6, likewise numerals are designated to components similar to those of the aberration correcting apparatus S1 of the first embodiment, and their detailed description will not be repeated. In FIG. 7, likewise step numbers are designated to processes similar to the aberration correction amount re-setting process (refer to FIG. 3) of the first embodiment, and the detailed description will not be repeated.

In the aberration correcting apparatus S1 of the first embodiment, at the time of calculating the aberration correction amount applied when the tracking servo loop is in the open state, both of the residual error in the focus error signal Sfe and the amplitude of the tracking error signal Ste are used. In the following third embodiment, at the time of calculating the aberration correction amount applied when the tracking servo loop is in the open state, only the residual error in the focus error signal Sfe is used.

In the aberration correcting apparatus S1 of the first embodiment, at the time of calculating the aberration correction amount applied when the tracking servo loop is in the close state, the case where the jitter amount in the decode signal Sd or the error rate becomes the minimum is applied. In the third embodiment described below, when the amplitude of the RF signal Srf is the maximum, the aberration correction amount applied when the tracking servo loop is in the close state is set as the optimum value.

As shown in FIG. 6, an aberration correcting apparatus S3 of the third embodiment has a configuration obtained by eliminating the amplitude detector 7 from the aberration correcting apparatus S1 of the first embodiment, having an LPF 16 in place of the decoder 9 and the jitter/error rate detector 10, and having a maximum value detector 15 as detecting means.

In the configuration, the RF signal Srf is output to the LPF 16 and also a decoder which is not shown in FIG. 6 and provided for a reproducing process.

The LPF 16 eliminates unnecessary high-frequency components included in the RF signal Srf, thereby generating an LPF signal Slp, and outputs the LPF signal Slp to the maximum value detector 15.

The maximum value detector 15 detects the maximum value of the amplitude of the LPF signal Slp accompanying a change in the aberration correction amount used for correction in the liquid crystal panel 2, generates a maximum value signal Smx at the detection timing, and outputs the generated maximum value signal Smx to the CPU 12.

In the above configuration, as an entire reproducing process executed by an information reproducing apparatus including the aberration correcting apparatus S3 of the third embodiment, a process similar to the reproducing process in the first embodiment shown in FIG. 2 is executed. As the aberration correction amount resetting process (step S4 in FIG. 2), process shown in FIG. 7 is executed.

Concretely, as shown in FIG. 7, when the aberration correction amount resetting process starts (step S4), processes similar to those in the steps S41 and S42 shown in FIG. 3 are performed.

The information is retrieved while changing the aberration correction amount used for correction in the liquid crystal panel 2. On the basis of the maximum value signal Smx output from the maximum value detector 15 accompanying the operation, whether the value indicated by the maximum value signal Smx becomes the maximum accompanying a change in the aberration correction amount (step S43) or not is determined (step S50).

When it is determined in the step S50 that the amplitude of the RF signal Srf has not become the maximum value (NO in step S50), the program returns to the process in the step S42 to make a check on another aberration correction amount. On the other hand, when the amplitude becomes the maximum value (YES in step S50), the aberration correction amount at that time is set as the aberration correction amount when the tracking servo loop is in the close state and stored in a not-shown memory in the CPU 12 (step S44).

After that, processes similar to those in the steps S46 and S47 shown in FIG. 3 are executed. When it is determined in the step S47 that the residual error in the focus error signal Sfe has not become the minimum value (NO in step S47), the program returns to the process in the step S46 to make a check on another aberration correction amount. On the other hand, when the residual error becomes the minimum value (YES in step S47), the aberration correction amount is set as the aberration correction amount when the tracking servo loop is in the open state and stored in a not-shown memory in the CPU 12 (step S49). The program shifts to the process of step S5 shown in FIG. 2.

As described above, in the operation of the aberration correcting apparatus S3 of the third embodiment, the astigmatism correction amount is optimized by being switched between the state where the tracking servo loop is open and the state where the tracking servo loop is closed. As a result, the amount of occurrence of the astigmatism in the 45-degree direction in the open state can be reduced.

Therefore, the track cross noise caused by the astigmatism in the 45-degree direction is also reduced, so that occurrence of abnormal operation in the actuator for tracking servo can be suppressed.

The aberration correction amount applied when the tacking servo loop is in the close state is set so that the amplitude of the RF signal Srf for detecting information recorded on the optical disk DK becomes the maximum. Necessary information can be reliably detected and reproduced from the optical disk DK.

Further, the aberration correction amount applied when the tacking servo loop is in the open state is set so that the residual error in the focus error signal Sfe becomes the minimum in the state where the tracking servo loop is open. Thus, the astigmatism in the 45-degree direction which occurs in the open state is reduced, and track cross noise can be further reduced.

Moreover, the aberration correction amounts are updated as necessary when the optical disk DK is inserted in the information reproducing apparatus including the aberration correcting apparatus S3 of the third embodiment. Consequently, the optimum aberration correction amount can be obtained and used for each of the optical disks DK from which recorded information is to be reproduced.

In each of the foregoing embodiments, the case of applying the present invention to the aberration correcting apparatus included in the information reproducing apparatus has been described. Obviously, the present invention can be also applied to an aberration correcting apparatus included in an information recording apparatus for optically recording information onto the optical disk DK.

A general computer can be also utilized as the CPU 12 of the embodiments by recording programs corresponding to the flowcharts of FIGS. 2, 3, 5, and 7 into an information recording medium such as a flexible disk or hard disk, or obtaining the programs via the Internet or the like and recording them, and reading and executing the programs by the computer.

1. An aberration correcting apparatus comprising:
a correcting device which optically corrects astigmatism included in a light beam used for optically recording and/or reproducing information to/from a recording medium;
a storing device which stores first correction amount information indicative of a correction amount of the astigmatism when a tracking servo loop for controlling a condensing position of the light beam in a direction parallel to an information recording face in the recording medium is in a closed state and second correction amount information indicative of a correction amount of the astigmatism when the tracking servo loop is in an open state; and
a switching output device, in the closed state, which reads the stored first correction amount information from the storing device and outputting the read first correction amount information to the correcting device and, in the open state, which reads the stored second correction amount information from the storing device and outputting the read second correction amount information to the correcting device,
wherein the correcting device corrects the astigmatism by using either the first correction amount information or the second correction amount information which is output.

2. The aberration correcting apparatus according to claim 1, further comprising:
a detecting device, in the closed state, which detects amplitude of a detection signal obtained by detecting the information recorded on the recording medium by using the light beam from the recording medium while changing the correction amount; and
a storage controlling device which stores, as the first correction amount information, information indicative of the correction amount when the detected amplitude becomes the maximum into the storing device.

3. The aberration correcting apparatus according to claim 1, further comprising:
a detecting device, in the closed state, which detects the information recorded on the recording medium from the recording medium by using the light beam while changing the correction amount and, further, detecting a value of either a jitter amount or an error rate in reproduction information obtained by decoding the detected information; and
a storage controlling device which stores, as the first correction amount information, information indicative of the correction amount when the detected value becomes the minimum into the storing device.

4. The aberration correcting apparatus according to claim 2,
wherein when the recording medium is loaded into an information processing apparatus including the aberration correcting apparatus, the storage controlling device updates the first correction amount information and stores the updated information into the storing device.

5. The aberration correcting apparatus according to claim 1, further comprising:
an error detecting device, in the open state, which detects a residual error included in a focus error signal in a focus servo for controlling the light condensing position in a direction perpendicular to the information recording face while changing the correction amount; and
a storage controlling device which stores, as the second correction amount information, information indicative of the correction amount when the detected residual error becomes the minimum into the storing device.

6. The aberration correcting apparatus according to claim 5, further comprising:
an amplitude detecting device, in the open state, which detects amplitude of a tracking error signal in the tracking servo while changing the correction amount; and
a storage controlling device which stores, as the second correction amount information, information indicative of the correction amount when the detected residual error becomes the minimum and the detected amplitude becomes equal to or larger than preset threshold amplitude into the storing device.

7. The aberration correcting apparatus according to claim 5,
wherein when the recording medium is loaded into an information processing apparatus including the aberration correcting apparatus, the storage controlling device updates the second correction amount information and stores the updated information into the storing device.

8. A recording medium where an aberration correction program is computer-readably recorded,
said aberration correcting program making a computer included in an aberration correcting apparatus having a correcting device which optically corrects astigmatism included in a light beam used for optically recording and/or reproducing information to/from a recording medium, and which corrects the astigmatism by using either first correction amount information or the second correction amount information, function as:
a storing device which stores the first correction amount information indicative of a correction amount of the astigmatism when a tracking servo loop for controlling a condensing position of the light beam in a direction parallel to an information recording face in the recording medium is in a closed state, and the second correction amount information indicative of a correction amount of the astigmatism when the tracking servo loop is in an open state; and
a switching output device, in the closed state, which reads the stored first correction amount information from the computer functioning as the storing device and outputting the read first correction amount information to the correcting device and, in the open state, which reads the stored second correction amount information from the computer functioning as the storing device and outputting the read second correction amount information to the correcting device.
